(19) United States
(12) Patent Application Publication
(10) Pub. No.: US 2023/0237730 A1
(43) Pub. Date: Jul. 27, 2023

(54) MEMORY STRUCTURES TO SUPPORT CHANGING VIEW DIRECTION

(71) Applicant: META PLATFORMS TECHNOLOGIES, LLC, Menlo Park, CA (US)

(72) Inventor: Larry Seiler, Redmond, WA (US)

(21) Appl. No.: 17/581,819

(22) Filed: Jan. 21, 2022

(51) Int. Cl. G06T 15/10; H04N 13/344; H04N 13/398; G06T 15/06; G09G 3/32

(52) U.S. Cl. CPC G06T 15/10; H04N 13/344; H04N 13/398; G06T 15/06; G09G 3/32

(57) ABSTRACT

In one embodiment, a computing system may store, in a memory unit, a first array of pixel values to represent a scene as viewed along a first viewing direction. The first array of pixel values may correspond to a number of positions uniformly distributed in an angle space. The system may determine an angular displacement from the first viewing direction to a second viewing direction. The system may determine a second array of pixel values to represent the scene as viewed along the second viewing direction by: (1) shifting a portion of the first array of pixel values in the memory unit based on the angular displacement, or (2) reading a portion of the first array of pixel values from the memory unit using an address offset determined based on the angular displacement. The system may output the second array of pixel values to a display.

### TECHNICAL FIELD

This disclosure generally relates to artificial reality, in particular to generating free-viewpoint videos.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

Particular embodiments described herein relate to systems and methods of generating subframes at a high frame rate based on real-time or close-real-time view directions of the user. The system may generate or receive mainframes that are generated at a mainframe rate. The mainframes may be generated by a remote or local computer based on the content data and may be generated at a relatively low frame rate (e.g., 30 Hz) comparing the subframe rate to accommodate the user's head motion. The system may use a display engine to generate composited frames based on the received mainframe. The composited frames may be generated by the display engine using a ray-casting and sampling process at a higher framerate (e.g., 90 Hz). The frame rate of the composited frames may be limited by the processing speed of the graphic pipeline of the display engine. Then, the system may store the composited frame in a frame buffer and use the pixel data in the frame buffer to generate subframes at an even higher frame rate according to the real-time or close-real-time view directions of the user.

At a high level, the method may use two alternative memory organization frameworks to convert a composed frame (composed by the display engine based on a mainframe) into multiple sub-frames that are adjusted for changes in view direction of the user. The first memory organization framework may use a frame buffer memory local to the display panel having the LEDs (e.g., located in the same die as the LEDs or in a die stacked behind the LEDs and aligned to LEDs). Under the first memory organization framework, the system may shift the pixel data stored in the buffer memory according to the approximate view direction (e.g., view direction as measured in real-time or close-real-time as it changes). For example, the system may use the first memory architecture to generate 4 subframes per composited frame resulting in 360 Hz for the subframe rate. The second memory organization framework may use a frame buffer memory remote to the display panel hosting the LEDs. For example, the frame buffer may be located in the same die as the renderer in the display engine, which is remote to but in communication with the display panel hosting the LEDs. The system may shift the address offsets used for reading the frame buffer according the approximate view direction of the user and read the pixel data from the frame buffer memory to generate the new subframes. For example, the system may use this memory architecture to generate 100 subframes per composited frame resulting in 9 kHz for the subframe rate.

To allow the subframe to be correctly generated by shifting the pixel data in the frame buffer or shifting the reading offset for reading the pixel data, the composited frame and the subframe generated according to the user's view direction may include pixel data corresponding to a number of pixel positions on the view plane that are uniformly distributed in an angle space (rather than in a tangent space). Then, the pixel data may be stored in a frame buffer (e.g., integrated with the display panel having the light-emitting elements or integrated with the display engine which is remote to the display panel with the light-emitting elements). When the system detect the user head motion, the system may generate the corresponding subframe in response to the user's head motion and in accordance with an approximate view direction of the user by adjusting pixel data stored in the frame buffer or adjusting address offsets for the pixel data according to the view direction of the user as it changes over time. The approximate view direction of the user may be a real-time or close-real-time view direction of the user as measured by the head-tracking system rather than predicted based on head direction data of previous frames.

When the pixel values are to be output to LEDs, the system may use the distortion correction block, which samples the pixel values based on the LED locations/lens distortion characteristics, to correct such distortions. Thus, the system can use the sampling process to account for the fractional differences in angles considering both the lens distortions and the LED location distortions. The rate for rendering the mainframes, composited frames, and the rate at which subframes are generated may be adjusted dynamically and independently. When the upstream system indicates that there is fast changing content (e.g., fast moving objects) or there is likely to be occlusion changes (e.g., changing FOVs), the system may increase the render rate of the mainframes, but the subframe rate may be kept the same being independent from the mainframe rate or/and the composited frame rate because the user's view direction is not moving that much. On the other hand, when the user's head moves rapidly, the system may increase the subframe rate independently without increasing the mainframe rate or/and the composited frame rate because the content itself is not changing that much. As a result, the system may allow the subframes to be generated higher frame rates (e.g., subframes at 360 Hz on the basis of 4 subframe per composed frame with a framerate of 90 Hz) to reduce the flashing and flickering artifacts. This may also allow LEDs to be turned on for more of the display time (e.g., 100% duty cycle), which can improve brightness and reduce power consumption because the reduction in the driving current levels. The system may allow the frame distortion correction to be made based on late-latched eye velocity, rather than predicted future eye velocity in advance of rendering each frame. The system may allow the display rate to be adaptive to the amount head motion and allows the render rate to be adaptive to the rate at which the scene and its occlusions are changing.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system.

FIG. 1B illustrates an example augmented reality system.

FIG. 1C illustrates an example architecture of a display engine.

FIG. 1D illustrates an example graphic pipeline of the display engine for generating display image data.

FIG. 2A illustrates an example system architecture having a frame buffer in a different component remote to the display chips.

FIG. 2B-2C illustrate example system architectures and having frame buffer(s) located on the display chip(s).

FIG. 3A illustrates an example scheme with uniformly spaced pixels.

FIG. 3B illustrate an example scenario where the view direction is rotated and the system tries to reuse the pixel values for the rotated view plane.

FIG. 3C illustrates an example scheme where the pixels are uniformly spaced in an angle space rather than the view plane.

FIG. 3D illustrates an example scheme where the view plane is rotated and the system tries to reuse the pixel values.

FIG. 4A illustrates an example angle space pixel array with 16×16 pixels comparing to a 16×16 tangent space grid.

FIG. 4B illustrates an example angle space pixel array with 24×24 pixels comparing to a 16×16 tangent space grid.

FIG. 4C illustrates an example LED array including 64 LEDs on a 96 degree-wide angle space grid.

FIG. 5A illustrates an example pattern of an LED array due to lens distortion.

FIG. 5B illustrates an example pattern of an LED array with the same pincushion distortion in FIG. 5A but mapped into an angle space.

FIG. 6A illustrates an example architecture including a tile processor and four pixel memory units.

FIG. 6B illustrates an example memory lay out to allow parallel per-memory unit shifting.

FIG. 6C illustrates an example memory layout to support pixel shifting with a 2×2 access per pixel block.

FIG.7 illustrates an example method of adjusting display content in according to the user's view directions.

FIG. 8 illustrates an example computer system.

### DESCRIPTION OF EXAMPLE EMBODIMENTS

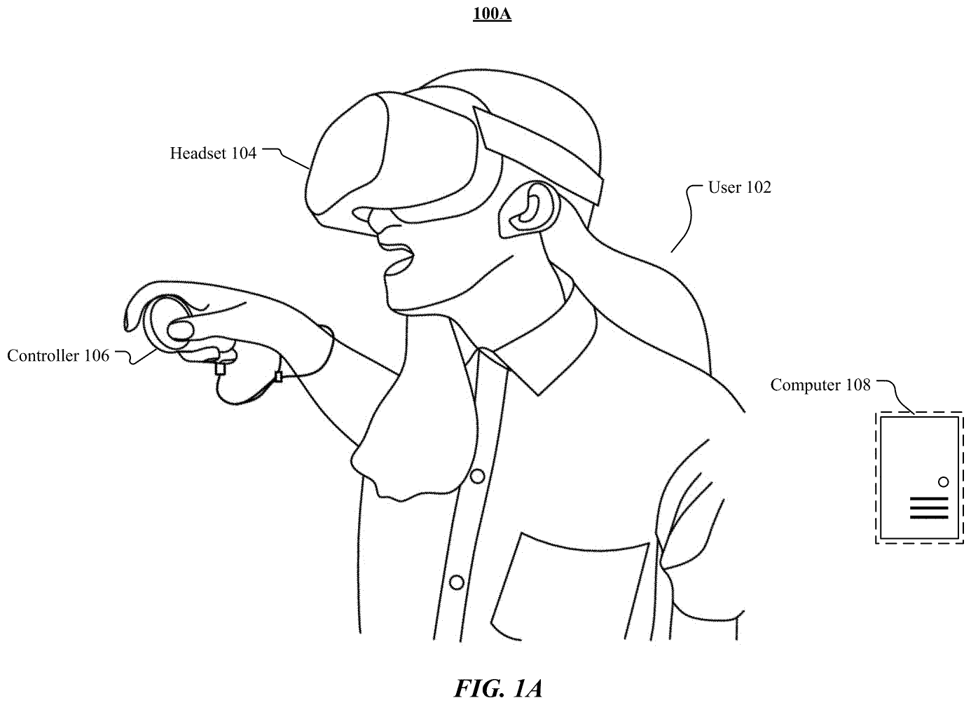

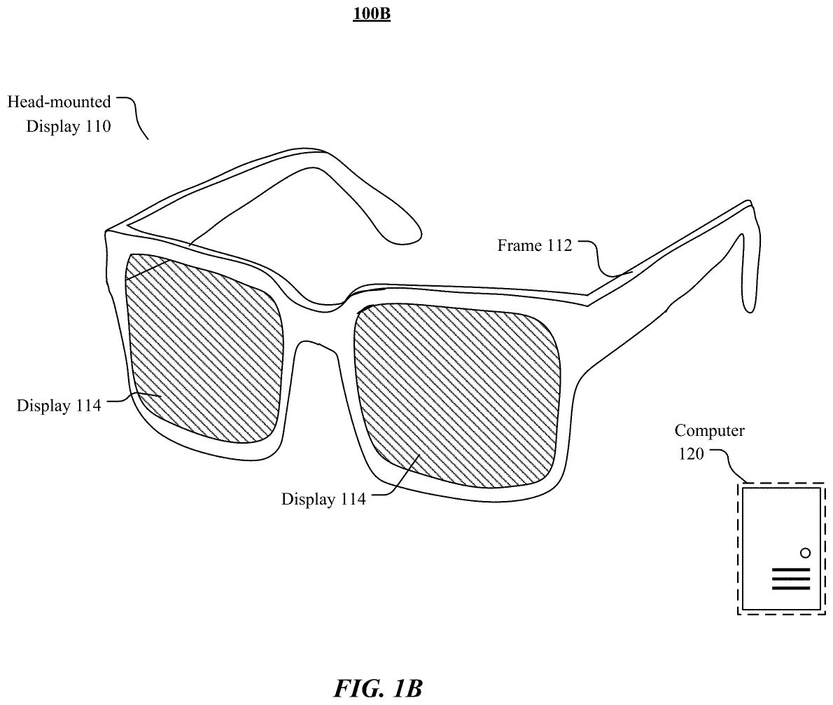

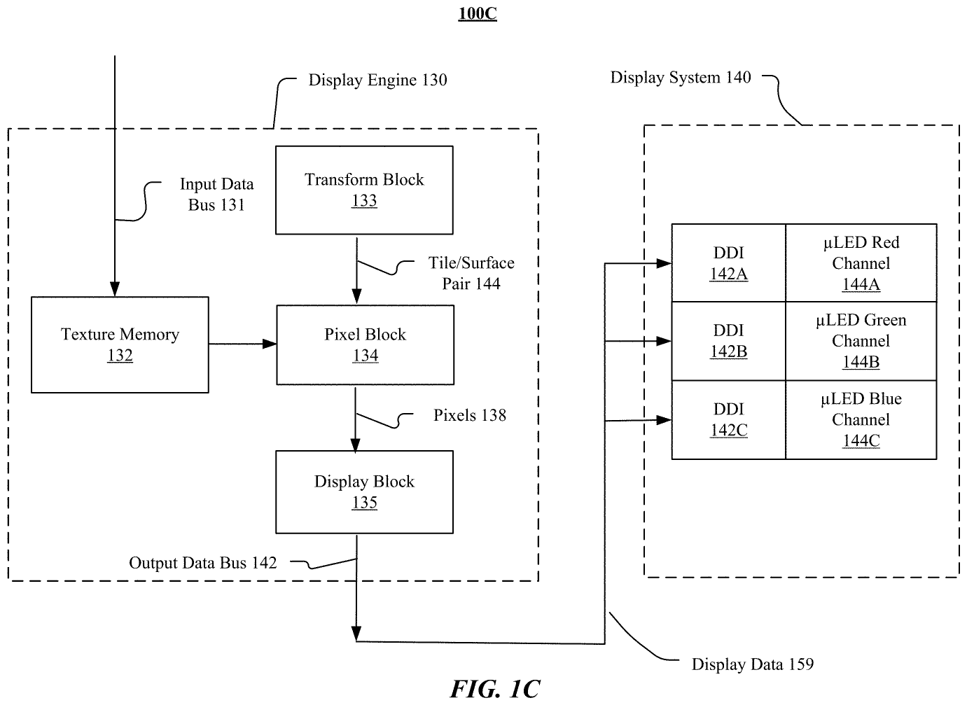

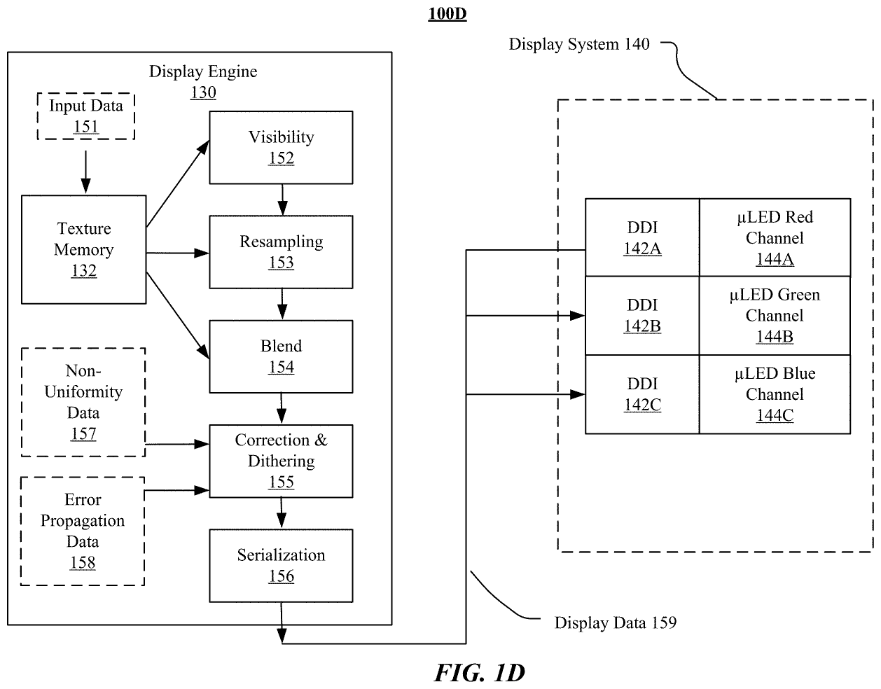

FIG. 1A illustrates an example artificial reality system 100A. In particular embodiments, the artificial reality system 100 may comprise a headset 104, a controller 106, and a computing system 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may be referred as a head-mounted display (HDM). The controller 106 may comprise a trackpad and one or more buttons. The controller 106 may receive inputs from the user 102 and relay the inputs to the computing system 108. The controller 206 may also provide haptic feedback to the user 102. The computing system 108 may be connected to the headset 104 and the controller 106 through cables or wireless connections. The computing system 108 may control the headset 104 and the controller 106 to provide the artificial reality content to and receive inputs from the user 102. The computing system 108 may be a standalone host computer system, an on-board computer system integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing system 120. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The augmented reality system 100B may further include a controller comprising a trackpad and one or more buttons. The controller may receive inputs from users and relay the inputs to the computing system 120. The controller may also provide haptic feedback to users. The computing system 120 may be connected to the HMD 110 and the controller through cables or wireless connections. The computing system 120 may control the HMD 110 and the controller to provide the augmented reality content to and receive inputs from users. The computing system 120 may be a standalone host computer system, an on-board computer system integrated with the HMD 110, a mobile device, or any other hardware platform capable of providing artificial reality content to and receiving inputs from users.

FIG. 1C illustrates an example architecture 100C of a display engine 130. In particular embodiments, the processes and methods as described in this disclosure may be embodied or implemented within a display engine 130 (e.g., in the display block 135). The display engine 130 may include, for example, but is not limited to, a texture memory 132, a transform block 133, a pixel block 134, a display block 135, input data bus 131, output data bus 142, etc. In particular embodiments, the display engine 130 may include one or more graphic pipelines for generating images to be rendered on the display. For example, the display engine may use the graphic pipeline(s) to generate a series of subframe images based on a mainframe image and a viewpoint or view angle of the user as measured by one or more eye tracking sensors. The mainframe image may be generated or/and loaded in to the system at a mainframe rate of 30-90 Hz and the subframe rate may be generated at a subframe rate of 1-2 kHz. In particular embodiments, the display engine 130 may include two graphic pipelines for the user's left and right eyes. One of the graphic pipelines may include or may be implemented on the texture memory 132, the transform block 133, the pixel block 134, the display block 135, etc. The display engine 130 may include another set of transform block, pixel block, and display block for the other graphic pipeline. The graphic pipeline(s) may be controlled by a controller or control block (not shown) of the display engine 130. In particular embodiments, the texture memory 132 may be included within the control block or may be a memory unit external to the control block but local to the display engine 130. One or more of the components of the display engine 130 may be configured to communicate via a high-speed bus, shared memory, or any other suitable methods. This communication may include transmission of data as well as control signals, interrupts or/and other instructions. For example, the texture memory 132 may be configured to receive image data through the input data bus 211. As another example, the display block 135 may send the pixel values to the display system 140 through the output data bus 142. In particular embodiments, the display system 140 may include three color channels (e.g., 114A, 114B, 114C) with respective display driver ICs (DDIs) of 142A, 142B, and 143B. In particular embodiments, the display system 140 may include, for example, but is not limited to, light-emitting diode (LED) displays, organic light-emitting diode (OLED) displays, active matrix organic light-emitting diode (AMLED) displays, liquid crystal display (LCD), micro light-emitting diode (ILED) display, electroluminescent displays (ELDs), or any suitable displays.

In particular embodiments, the display engine 130 may include a controller block (not shown). The control block may receive data and control packages such as position data and surface information from controllers external to the display engine 130 though one or more data buses. For example, the control block may receive input stream data from a body wearable computing system. The input data stream may include a series of mainframe images generated at a mainframe rate of 30-90 Hz. The input stream data including the mainframe images may be converted to the required format and stored into the texture memory 132. In particular embodiments, the control block may receive input from the body wearable computing system and initialize the graphic pipelines in the display engine to prepare and finalize the image data for rendering on the display. The data and control packets may include information related to, for example, one or more surfaces including texel data, position data, and additional rendering instructions. The control block may distribute data as needed to one or more other blocks of the display engine 130. The control block may initiate the graphic pipelines for processing one or more frames to be displayed. In particular embodiments, the graphic pipelines for the two eye display systems may each include a control block or share the same control block.

In particular embodiments, the transform block 133 may determine initial visibility information for surfaces to be displayed in the artificial reality scene. In general, the transform block 133 may cast rays from pixel locations on the screen and produce filter commands (e.g., filtering based on bilinear or other types of interpolation techniques) to send to the pixel block 134. The transform block 133 may perform ray casting from the current viewpoint of the user (e.g., determined using the headset's inertial measurement units, eye tracking sensors, and/or any suitable tracking/localization algorithms, such as simultaneous localization and mapping (SLAM)) into the artificial scene where surfaces are positioned and may produce tile/surface pairs 144 to send to the pixel block 134. In particular embodiments, the transform block 133 may include a four-stage pipeline as follows. A ray caster may issue ray bundles corresponding to arrays of one or more aligned pixels, referred to as tiles (e.g., each tile may include 16×16 aligned pixels). The ray bundles may be warped, before entering the artificial reality scene, according to one or more distortion meshes. The distortion meshes may be configured to correct geometric distortion effects stemming from, at least, the eye display systems the headset system. The transform block 133 may determine whether each ray bundle intersects with surfaces in the scene by comparing a bounding box of each tile to bounding boxes for the surfaces. If a ray bundle does not intersect with an object, it may be discarded. After the tile-surface intersections are detected, the corresponding tile/surface pairs may be passed to the pixel block 134.

In particular embodiments, the pixel block 134 may determine color values or grayscale values for the pixels based on the tile-surface pairs. The color values for each pixel may be sampled from the texel data of surfaces received and stored in texture memory 132. The pixel block 134 may receive tile-surface pairs from the transform block 133 and may schedule bilinear filtering using one or more filer blocks. For each tile-surface pair, the pixel block 134 may sample color information for the pixels within the tile using color values corresponding to where the projected tile intersects the surface. The pixel block 134 may determine pixel values based on the retrieved texels (e.g., using bilinear interpolation). In particular embodiments, the pixel block 134 may process the red, green, and blue color components separately for each pixel. In particular embodiments, the display may include two pixel blocks for the two eye display systems. The two pixel blocks of the two eye display systems may work independently and in parallel with each other. The pixel block 134 may then output its color determinations (e.g., pixels 138) to the display block 135. In particular embodiments, the pixel block 134 may composite two or more surfaces into one surface to when the two or more surfaces have overlapping areas. A composed surface may need less computational resources (e.g., computational units, memory, power, etc.) for the resampling process.

In particular embodiments, the display block 135 may receive pixel color values from the pixel block 134, covert the format of the data to be more suitable for the scanline output of the display, apply one or more brightness corrections to the pixel color values, and prepare the pixel color values for output to the display. In particular embodiments, the display block 135 may each include a row buffer and may process and store the pixel data received from the pixel block 134. The pixel data may be organized in quads (e.g., 2×2 pixels per quad) and tiles (e.g., 16×16 pixels per tile). The display block 135 may convert tile-order pixel color values generated by the pixel block 134 into scanline or row-order data, which may be required by the physical displays. The brightness corrections may include any required brightness correction, gamma mapping, and dithering. The display block 135 may output the corrected pixel color values directly to the driver of the physical display (e.g., pupil display) or may output the pixel values to a block external to the display engine 130 in a variety of formats. For example, the eye display systems of the headset system may include additional hardware or software to further customize backend color processing, to support a wider interface to the display, or to optimize display speed or fidelity.

In particular embodiments, the dithering methods and processes (e.g., spatial dithering method, temporal dithering methods, and spatio-temporal methods) as described in this disclosure may be embodied or implemented in the display block 135 of the display engine 130. In particular embodiments, the display block 135 may include a model-based dithering algorithm or a dithering model for each color channel and send the dithered results of the respective color channels to the respective display driver ICs (DDIs) (e.g., 142A, 142B, 142C) of display system 140. In particular embodiments, before sending the pixel values to the respective display driver ICs (e.g., 142A, 142B, 142C), the display block 135 may further include one or more algorithms for correcting, for example, pixel non-uniformity, LED non-ideality, waveguide non-uniformity, display defects (e.g., dead pixels), display degradation, etc. U.S. patent application Ser. No. 16/998,860, entitled “Display Degradation Compensation,” first named inventor “Edward Buckley,” filed on 20 Aug. 2020, which discloses example systems, methods, and processes for display degradation compensation, is incorporated herein by reference.

In particular embodiments, graphics applications (e.g., games, maps, content-providing apps, etc.) may build a scene graph, which is used together with a given view position and point in time to generate primitives to render on a GPU or display engine. The scene graph may define the logical and/or spatial relationship between objects in the scene. In particular embodiments, the display engine 130 may also generate and store a scene graph that is a simplified form of the full application scene graph. The simplified scene graph may be used to specify the logical and/or spatial relationships between surfaces (e.g., the primitives rendered by the display engine 130, such as quadrilaterals or contours, defined in 3D space, that have corresponding textures generated based on the mainframe rendered by the application). Storing a scene graph allows the display engine 130 to render the scene to multiple display frames and to adjust each element in the scene graph for the current viewpoint (e.g., head position), the current object positions (e.g., they could be moving relative to each other) and other factors that change per display frame. In addition, based on the scene graph, the display engine 130 may also adjust for the geometric and color distortion introduced by the display subsystem and then composite the objects together to generate a frame. Storing a scene graph allows the display engine 130 to approximate the result of doing a full render at the desired high frame rate, while actually running the GPU or display engine 130 at a significantly lower rate.

FIG. 1D illustrates an example graphic pipeline 100D of the display engine 130 for generating display image data. In particular embodiments, the graphic pipeline 100D may include a visibility step 152, where the display engine 130 may determine the visibility of one or more surfaces received from the body wearable computing system. The visibility step 152 may be performed by the transform block (e.g., 2133 in FIG. 1C) of the display engine 130. The display engine 130 may receive (e.g., by a control block or a controller) input data 151 from the body-wearable computing system. The input data 151 may include one or more surfaces, texel data, position data, RGB data, and rendering instructions from the body wearable computing system. The input data 151 may include mainframe images with 30-90 frames per second (FPS). The main frame image may have color depth of, for example, 24 bits per pixel. The display engine 130 may process and save the received input data 151 in the texel memory 132. The received data may be passed to the transform block 133 which may determine the visibility information for surfaces to be displayed. The transform block 133 may cast rays for pixel locations on the screen and produce filter commands (e.g., filtering based on bilinear or other types of interpolation techniques) to send to the pixel block 134. The transform block 133 may perform ray casting from the current viewpoint of the user (e.g., determined using the headset's inertial measurement units, eye trackers, and/or any suitable tracking/localization algorithms, such as simultaneous localization and mapping (SLAM)) into the artificial scene where surfaces are positioned and produce surface-tile pairs to send to the pixel block 134.

In particular embodiments, the graphic pipeline 100D may include a resampling step 153, where the display engine 130 may determine the color values from the tile-surfaces pairs to produce pixel color values. The resampling step 153 may be performed by the pixel block 134 in FIG. 1C) of the display engine 130. The pixel block 134 may receive tile-surface pairs from the transform block 133 and may schedule bilinear filtering. For each tile-surface pair, the pixel block 134 may sample color information for the pixels within the tile using color values corresponding to where the projected tile intersects the surface. The pixel block 134 may determine pixel values based on the retrieved texels (e.g., using bilinear interpolation) and output the determined pixel values to the respective display block 135.

In particular embodiments, the graphic pipeline 100D may include a bend step 154, a correction and dithering step 155, a serialization step 156, etc. In particular embodiments, the bend step, correction and dithering step, and serialization steps of 154, 155, and 156 may be performed by the display block (e.g., 135 in FIG. 1C) of the display engine 130. The display engine 130 may blend the display content for display content rendering, apply one or more brightness corrections to the pixel color values based on non-uniformity data 157, perform one or more dithering algorithms for dithering the quantization errors (e.g., determined based on the error propagation data 158) both spatially and temporally, serialize the pixel values for scanline output for the physical display, and generate the display data 159 suitable for the display system 140. The display engine 130 may send the display data 159 to the display system 140. In particular embodiments, the display system 140 may include three display driver ICs (e.g., 142A, 142B, 142C) for the pixels of the three color channels of RGB (e.g., 144A, 144B, 144C).

Traditional AR/VR systems may render frames according to the user's view direction that are predicted based on head-tracking data associated with previous frames. However, it can be difficult to predict the view direction accurately into future for a time period that is needed for the rendering process. For example, it may be necessary to use the head position at the start of the frame and the predicted head position at the end of the frame to allow smoothly changing the head position as the frame is scanned out. At 100 frames per second, this delay may be 10 ms. It can be hard to accurately predict the user's view direction for 10 ms into future because the user may arbitrarily change the head motion at any time. This inaccuracy in the predicted view direction of the user may negatively affect the quality of the rendered frames. Furthermore, the head/eye tracking system used by AR/VR systems can track and predict the user's head/eye motion only up to a certain speed limit and the display engine or rendering pipeline may also have a rendering speed limit. Because of these speed limits, AR/VR systems may have an upper limit for its highest subframe rate. As a result, when the user moves his head/eye rapidly, the user may perceive artifacts (e.g., flickers or warping) due to the inaccurate view direction prediction and the limited subframe rate of the AR/VR system.

To solve this problem, particular embodiment of the system may generate subframes at a high frame rate based on the view directions of the user as measured by the eye/head tracking system in real-time or close-real-time. At a high level, the method may use two alternative memory organization frameworks to convert a composed frame (e.g., a frame composed by the display engine based on a mainframe) into multiple sub-frames that are adjusted for changes in view direction of the user. The first memory organization framework may use a frame buffer memory local to the display panel having the LEDs (e.g., located in the same die as the LEDs or in a die stacked behind the LEDs and aligned to LEDs). Under the first memory organization framework, the system may shift the pixel data stored in the buffer memory according to the approximate view direction (e.g., view direction as measured in real-time or close-real-time as it changes). For example, the system may use this memory architecture to generate 100 subframes for each composited frame, which has a frame rate of 90 Hz, resulting in a subframe rate of 9 kHz. The second memory organization framework may use a frame buffer memory remote to the display panel hosting the LEDs. For example, the frame buffer may be located in the same die as the renderer in the display engine, which is remote to (e.g., connected by the cables or wireless communication channels) but in communication with the display panel hosting the LEDs. The system may shift the address offsets used for reading the frame buffer according the approximate view direction of the user and read the pixel data from the frame buffer memory to generate the new subframes. For example, the system may use this memory architecture to generate 4 subframes for each composited frame, which has a frame rate of 90 Hz, resulting in a subframe rate of 360 Hz.

To allow the subframe to be correctly generated by shifting the pixel data in the frame buffer or shifting the reading offset for reading the pixel data, the composited frame and the subframe generated according to the user's view direction may include pixel data corresponding to a number of pixel positions on the view plane that are uniformly distributed in an angle space (rather than in a tangent space). Then, the pixel data may be stored in a frame buffer (e.g., integrated with the display panel having the light-emitting elements or integrated with the display engine which is remote to the display panel with the light-emitting elements). When the system detects the user's head motion, the system may generate the corresponding subframe in response to the user's head motion and in accordance with an approximate view direction of the user (as measured by the head tracking system) by adjusting pixel data stored in the frame buffer or adjusting address offsets for the pixel data according to the view direction of the user as it changes over time. The approximate view direction of the user may be a real-time or close-real-time view direction of the user as measured by the head tracking system rather than view directions that are predicted based on head direction data of previous frames.

Particular embodiments of the system may use either of the two memory architectures to generate subframes at a high frame rate and according to the user's view directions as measured in real-time or close-real-time. By avoiding using predicted view directions, which may be not accurate and may compromise the quality of the display content, the system may achieve better display quality with reduced flashing and flickering artifacts and provide better user experience. By using a higher subframe rate, which is independent to the mainframe rate, particular embodiments of the system may allow LEDs to be turned on for a longer display time during each display period (e.g., 100% duty cycle) and can improve brightness and reduce power consumption due to the reduction in the driving current levels. By resampling the pixel values based on the actual LEDs locations and the distortions of the system, particular embodiments of the system may allow the frame distortion to be corrected, and thus may provide improved display quality. By using independent mainframe rate and subframe rate, particular embodiments of the system may allow the display rate to be adaptive to the amount of the user's head motion and allow the render rate to be adaptive to the rate at which the scene and its occlusions are changing, providing optimal performance and optimized computational resource allocations.

In this disclosure, the term “mainframe rate” may refer to a frame rate that is used by the upper stream computing system to generate the mainframes. The term “composited frames” may refer to the frames that are rendered or generated by the render such as a GPU or display engine. A “composite frame” may also be referred to as a “rendered frame.” The term “rendering frame rate” may refer to a frame rate used by the render (e.g., the display engine or GPU) to render or compose composited frames (e.g., based on mainframes received from an upper stream computing system such as a headset or main computer).The term “display frame rate” may refer to a framerate that is used for updating the uLEDs and may be referred to as “display updating frame rate.” The display frame rate or display updating frame rate may equal to the “subframe rate” of the subframes generated by the system to update the uLEDs. In this disclosure, the term “display panel” or “display chip” may refer to a physical panel, a silicon chip, or a display component hosting an array of uLEDs or other types of LEDs. In this disclosure, the term “LED” may refer to any types of light-emitting elements including, for example, but not limited to, micro-LED (uLED). In this disclosure, the term “pixel memory unit” and “pixel block” may be used interchangeably.

In particular embodiments, the system may use a frame buffer memory to support rendering frames at a rendering frame rate that is different from a subframe rate (also referred to as a display frame rate) used for updating the uLED array. For example, the system may generate composited frames (using a display engine or a GUP for rendering display content) at a frame rate of 90 Hz, which may be a compromise result considering two competing factors: (1) the rendering rate needs to be slow enough to reduce the cost of rendering (e.g., ideally at a frame rate less than 60 Hz); and (2) the rate needs to be fast enough to reduce blur when the user's head moves (e.g., ideally at a frame rate up to 360 Hz). In particular embodiments, by using a 90 Hz display frame rate, the system may use a duty cycle of 10% to drive the uLEDs to reduce the blur to an acceptable level when the user moves his head at a high speed. However, the 10% duty cycle may result in strobing artifacts and may require significantly higher current levels to drive the uLEDs, which may increase the drive transistor size and reduce power efficiency.

In particular embodiments, the system may solve this problem by allowing the rendering frame rate used by the renderer (e.g., a GPU or display engine) to be decoupled from the subframe rate that is used to update the uLEDs. Both of the rendering frame rate used by the render and the subframe rate used for updating the uLEDs may be set to values that are suitable for their respective diverging requirements. Further, both the rendering frame rate and the subframe rate may be adaptive to support different workloads. For example, the rendering frame rate may be adaptive to the display content (e.g., based on whether there is a FOV change or whether there is a fast-moving object in the scene). As another example, the subframe rate for updating the uLEDs may be adaptive to the user's head motion speed.

In particular embodiments, the system may decouple rendering frame rate and subframe rate by building a specialized tile processor array, including a number of tile processors, into the silicon chip that drives the uLEDs. The tile processors may collectively store a full frame of pixel data. The system may shift or/and rotate the pixel data in the frame buffer as the user's head moves (e.g., along the left/right or/and up/down directions), so that these head movements can be accounted for with no need to re-render the scene at the subframe rate. In particular embodiments, even for VR displays that use large (e.g. 1″×1″) silicon chips to drive uLED arrays, the area on the silicon chip that drives the uLEDs may be entirely used by the drive transistors, leaving no room for the frame buffer. As an alternative, particular embodiments of the system may use a specialized buffer memory that could be built into the display engine (e.g., GPUs, graphics XRU chips) that drives the uLED array. The display engine may be remote (i.e., in different components) to the silicon chip that drives the uLEDs. The system may adjust the rendered frame to account for the user's head motion (e.g., along the left/right or/and up/down directions) by shifting the address offset used for reading the pixel data from the frame buffer which is remote to the uLED drivers. As a result, the subframes used for updating the uLEDs may account for the user's head motion and the frame rendering process by the display engine may not need to account for the user's head motion.

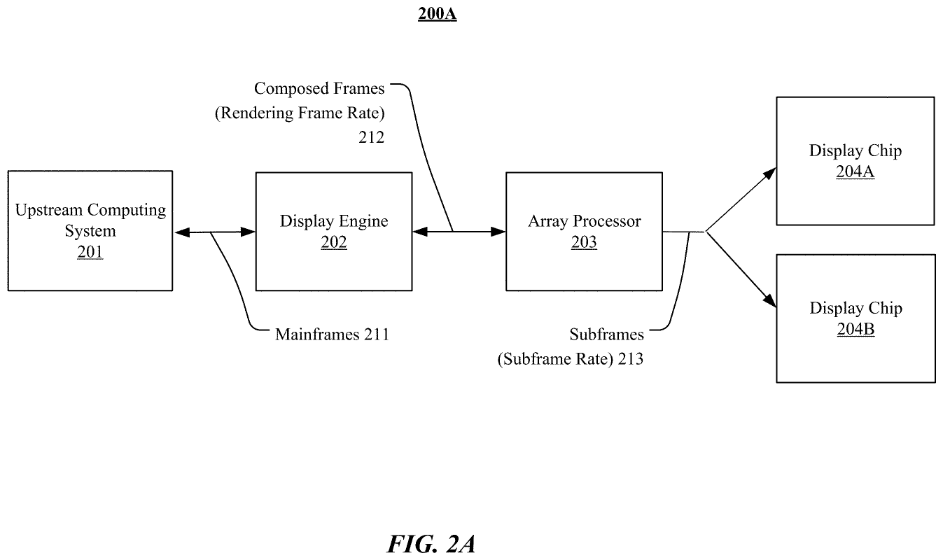

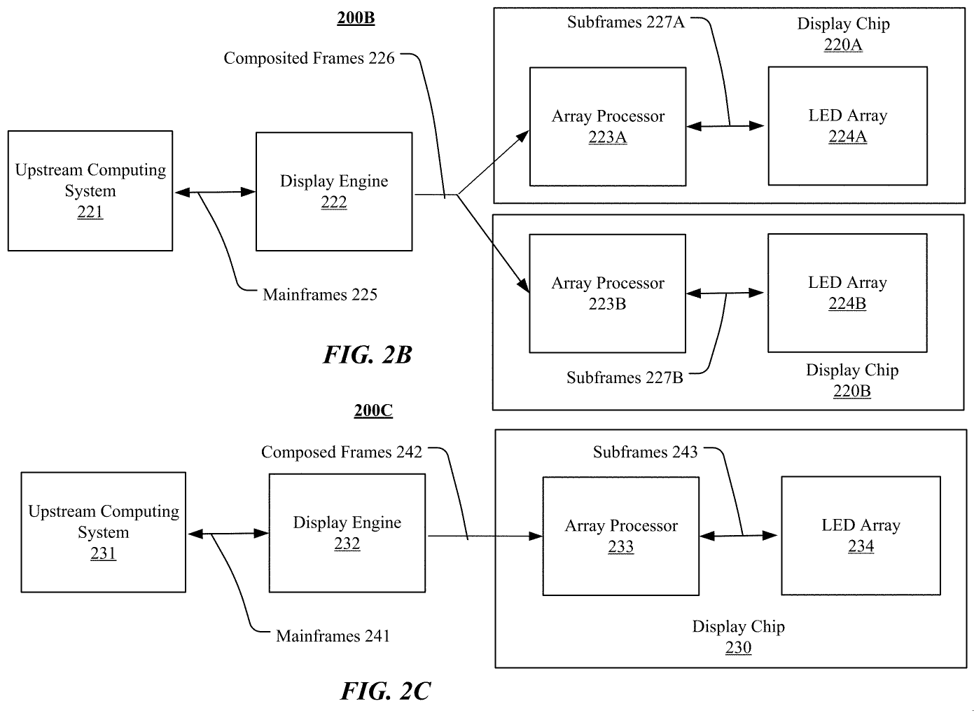

FIG. 2A illustrates an example system architecture 200A having a frame buffer in a different component remote to the display chips. As an example and not by way of limitation, the system architecture may include an upstream computing system 201, a display engine 202, a frame buffer 203, and one or two display chips (e.g., 204A, 204B). The upstream computing system 201 may be a computing unit on the headset or a computer in communication with the headset. The upstream computing system 201 may generate the mainframes 211 based on the AR/VR content to be displayed. The mainframes may be generated at a mainframe rate based on the display content. The upstream computing system 201 may transmit the mainframes 211 to the display engine 202. The display engine 202 may generate or compose the composited frames 212 based on the received mainframes 211, for example, using a ray casting and resampling method. For example, the display engine 202 may cast rays from a viewpoint to one or more surfaces of the scene to determine which surface is visible from that viewpoint based on whether this surface the casted rays intersect with the surface. Then, the display engine may use a resampling process to determine texture and then the pixel values for the visible surfaces as viewed from the viewpoint. Thus, the composited frames 212 may be generated in accordance with the most current viewpoint and view direction of the user. However, the composited frames 212 may be generated at a rendering frame rate (e.g., 90 Hz) depending the display content or/and the computational resources (e.g., computational capability and available power). Thus, the system may have a upper limitation on how high the render frame rate can be, and when the user's head moves in a high speed, the rendering frame rate, as limited by the computational resources, may not be enough to catch up the user's head motion. To address this problem, the composited frames 212 generated by the display engine 202 may be stored in the frame buffer 203. When the user's head moves, the system may generate corresponding subframes 213 according to the view directions of the user at a subframe rate (e.g., 4 subframes per composited frame) at a higher subframe frame rate (e.g., 360 Hz). The subframes 213 may be generated by shifting the address offset used for reading the frame buffer 203 based on the view directions of the user as measured by the head tracking system in real-time or close-real time. The subframes 213 may be generated at a subframe rate 213 that is much higher than the rendering frame rate 212. As such, the system may decouple the subframe rate used for updating the uLED array from the rendering frame rate used by the display engine to render the composited frames, and may update the LEDs with a high subframe rate without requiring the display engine to re-render at such a high frame rate.

In particular embodiments, when the frame buffer is located on the silicon chip hosting the uLED array, the system may shift pixels within the memory array to generate subframes. The specific regions of memory may be used to generate brightness for specific tiles of uLEDs. In particular embodiments, when the frame buffer is located at a different component remote to the silicon chip hosting the uLED array, the system may shift an address offset (Xₛ, Ys) that specifies the position of the origin within the memory array for reading the frame buffer to generate the subframes. When accessing location (X, Y) within the array, the corresponding memory address may be computed as follows:

address=((X+Xₛ)mod(W))+((Y+Yₛ)mod(H))×W (1)

where, (Xₛ, Yₛ) is the address offset, (X, Y) is the current address, W is the width of the frame buffer memory (e.g., as measured by the number of memory units corresponding to pixels), H is the height of the frame buffer memory (e.g., as measured by the number of memory units corresponding to pixels). In particular embodiments, the frame buffer position in memory may rotate in the left/right direction with changes in Xₛ and may rotate in the up/down direction with changes in Yₛ, all without actually moving any of the data already stored in memory. It is notable that that W and H may be not limited to the width and height of the uLED array, but may include an overflow region, so that the frame buffer on a VR device may be larger than the LED array to permit shifting the data with head movement.

FIG. 2B-2C illustrate example system architectures 200B and 200C having frame buffer(s) located on the display chip(s). In particular embodiments, the system may use an array of pixel memory (corresponding to the frame buffer) and tile processors to compute brightness levels for an array of LEDs as the head rotates during a display frame. The tile processors may be located on the display silicon chip behind the LED array. Each tile processor may access only memory that is stored near to the tile processor in the memory array. The pixel data stored in the pixel memory may be shifted in pixel memory so that the pixels each tile processor needs are always local. As an example and not by way of limitation, the architecture 200B may include an upstream computing system 221, a display engine 222, two frame buffers 223A and 223B on respective display chips of 220A and 220B, and two LED array 224A and 224B on respective display chips of 220A and 220B. The frame buffer 223A may be used to generate subframes 227A for updating the LED array 224A. The frame buffer 223B may be used to generate subframe 227B for updating the LED array 224B. As another example, the architecture 200C may include an upstream computing system 231, a display engine 232, a frame buffer 233 on the display chips 230, and a LED array 234 on the display chip of 230. The frame buffer 233 may be used to generate subframes 243 for updating the LED array 234. In both examples, the display engine (e.g., 222 or 232) may generate the composited frames (e.g., 226 or 242) at the corresponding rendering frame rates. The composited frames may be stored in respective frame buffers. The system may shift the pixel data stored in the frame buffer(s) to generate subframes according to the view directions of the user. The subframes for updating corresponding LED array may be generated at respective subframe rates that are higher than the rendering frame rate.

In particular embodiments, the system may use an array processor that is designed to be integrated to the silicon chip hosting an array of LEDs (e.g., uOLEDs). In particular embodiments, the system may allow the LEDs to be on close to 100% of the time of the display cycle (i.e., 100% duty cycle) and may provide desired brightness levels, without introducing blur due to head motion. In particular embodiments, the system may eliminate strobing and warping artifacts due to head motion and reducing LED power consumption. In particular embodiments, the system may include the elements including, for example, but not limited to, a pixel data input module, a pixel memory array and an array access interface, tile processors to compute LED driving signal parameter values, an LED data output interface, etc. In particular embodiments, the system may be bonded to a die having an array of LEDs (e.g., 3000×3000 array of uOLEDs). The system may use a VR display with a pancake lens and a 90 degree field of view (FOV). The system may use this high resolution to produce a retinal display, where individual LEDs may be not distinguishable by the viewer. In particular embodiments, the system may use four display chips to produce a larger array of LEDs (e.g., 6000×6000 array of uOLEDs). In particular embodiments, the system may support a flexible or variable display frame rate (e.g., up to 100 fps) for the rates of the mainframes and subframes. Changes in occlusion due to head movement and object movement/changes may be computed at the display frame rate. At 100 fps, changes in occlusion may not be visible to the viewer. The display frame rate may need not be fixed but could be varied depending on the magnitude of occlusion changes. In particular embodiments, the system may load frames of pixel data into the array processor, which may adjust the pixel data to generate subframes at a significantly higher subframe rate than 100 fps to account for changes in the user's viewpoint angle. In particular embodiments, the system may not support head position changes or object changes because that would change occlusion. In particular embodiments, the system may support head position changes or object changes by having a frame buffer storing pixel data that covers a larger area than actually displayed area of the scene.

In particular embodiments, the system may need extra power for introducing the buffer memory into the graphic pipeline. Much of the power for reading and writing operations of memory units may be already accounted for, since it replaces a multi-line buffer in the renderer/display interface. Power per byte access may increase, since the memory array may be large. However, if both the line buffer and the specialized frame buffer are built from SRAM, the power difference may be controlled within an acceptable range. Whether the data is stored in a line buffer or a frame buffer, each pixel may be written to SRAM once and read from SRAM once during the frame, so the active read/write power may be the same. Leakage power may be greater for the larger frame buffer memory than for the smaller line buffer, but this can be reduced significantly by turning off the address drivers for portions of the frame buffer that are not currently being accessed. A more serious challenge may be the extra power required to read and transmit data to the uLED array chip at a higher subframe rate. Inter-chip driving power may dramatically greater than the power for reading SRAM. Thus, the extra power can become a critical issue. In particular embodiments, the system may adopt a solution which continually alters the subframe rate based on the amount of head movement. For example, when the user's head is relatively still, the subframe rate may be 90 fps (i.e., 90 Hz) or less. Only when the head is moving quickly would the subframe rate increase, for example, to 360 fps (i.e., 360 Hz) for the fastest head movements. In particular embodiment, if a frame buffer allows up to 4 times of the subframe rate, the uLED duty cycle may be increased from 10% to 40% of the frame time. This may reduce the current level required to drive the uLEDs, which may reduce the power required and dramatically reduce the size of the drive transistors. In particular embodiments, the uLED duty cycle may be increased up to 100%, which may further reduce the current level and thus the power that is needed to drive the uLEDs.

In particular embodiments, the system may encounter user head rotation as fast as 300 degrees/sec. The system may load the display frame data into pixel memory at a loading speed up to 100 fps. Therefore, there may be up to 3 degrees of viewpoint angle change per display frame. As an example and not by way of limitation, with 3000 uOLEDs in a 90-degree of FOV, the movement of 3 degrees per frame may roughly correspond to 100 uOLEDs per frame. Therefore, to avoid aliasing, uOLED values may be computed at least 100 times per frame or 10,000 times per second. If a 3000×3000 display is processed in tiles of 32×32 uOLEDs per tile, there may be almost 100 horizontal swaths of tiles. This suggests that the display frame time may be divided into up to 100 subframe times, where one swath of pixel values may be loaded per subframe, replacing the entire pixel memory over the course of a display time. Individual swaths of uOLEDs could be turned on except during the one or two subframes while their pixel memory is being accessed. In particular embodiments, the pixel memory may be increased by the worst case supported change in view angle. Thus, supporting 3 degrees of angle change per display frame may require an extra 100 pixels on all four edges of the pixel array. As another example, with 6000 uOLEDs in a 90-degree of FOV, the movement of 3 degrees per frame may roughly correspond to 200 uOLEDs per frame. Therefore, to avoid aliasing, uOLED values may be computed at least 200 times per frame or up to 20,000 times per second.

In particular embodiments, the system may use an array processor that is integrated to the silicon chip hosting the array of LEDs (e.g., uOLEDs). The system may generate subframes that are adjusted for the user's view angle changes at a subframe rate and may correct all other effects related to, for example, but not limited to, object movement or changes in view position. For example, the system may correct pixel misalignment when generating the subframes. As another example, the system may generate the subframes in accordance with the view angle changes of the user while a display frame is being displayed. The view angle changes may be yaw (i.e., horizontal rotation) along the horizontal direction or pitch (i.e., vertical rotation) along the vertical direction. In particular embodiments, the complete view position updates may occur at the display frame rate (i.e., subframe rate), for example, with yaw and pitch being corrected at up to 100 sub-frames per display frame. In particular embodiments, the system may generate the subframes with corrections or adjustments according to torsion changes of the user. Torsion may be turning the head sideways and may occur mostly as part of turning the head to look at something up or down and to the side. The peak torsion angular speed and the percentage of a pixel of offset may occur at the edges of the screen in a single frame time. In particular embodiments, the system may generate the subframes with corrections or adjustments for translation changes. Translation changes may include moving the head in space (translation in head position) and may affect parallax and occlusion. The largest translation may occur when the users' head is also rotating. Peak display translation may be caused by the fast head movement and may be measured by the number of pixels of change in parallax and inter-object occlusion.

In particular embodiments, the system may generate subframes with corrections or adjustments based on the eye movement of the user during the display frame. The eye movement may a significant issue for raster scanned displays, since the raster scanning can result in an appearance of vertical lines tilting on left/right eye movement or objects expanding or shrinking (with corresponding change in brightness) on up/down eye movement. These effects may not occur when the system uses LEDs because LEDs may be flashed on all together after loading the image, rather than using raster scanning. As a result, eye movement may produce a blur effect instead of a raster scanning effect, just like the real world tends to blur with fast eye movement. The human brain may correct for this real world blur and the system may provide the same correction for always-on LEDs to eliminate the blur effect.

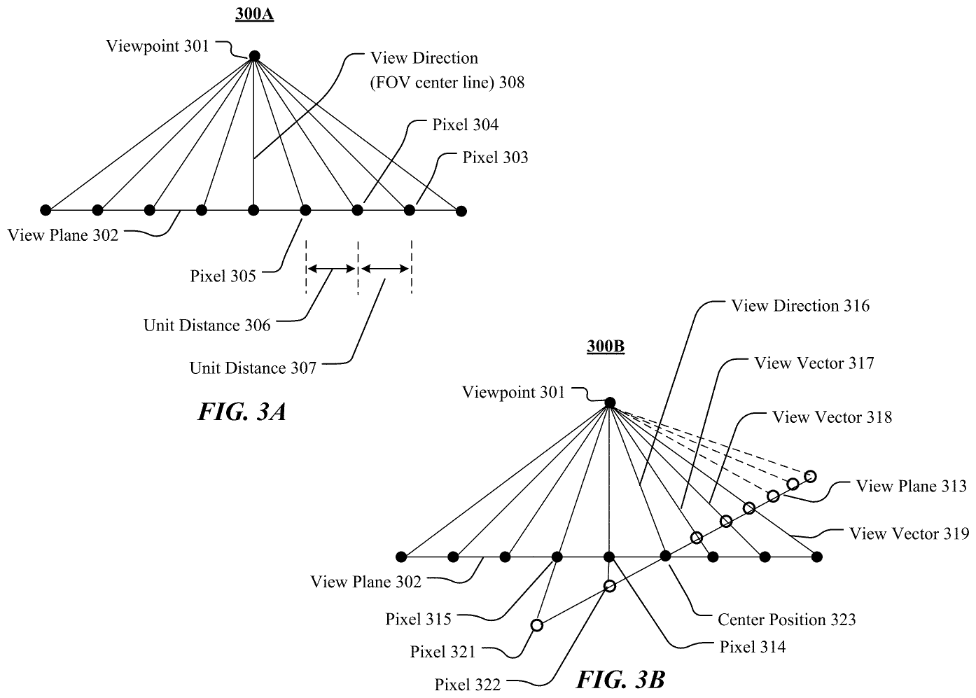

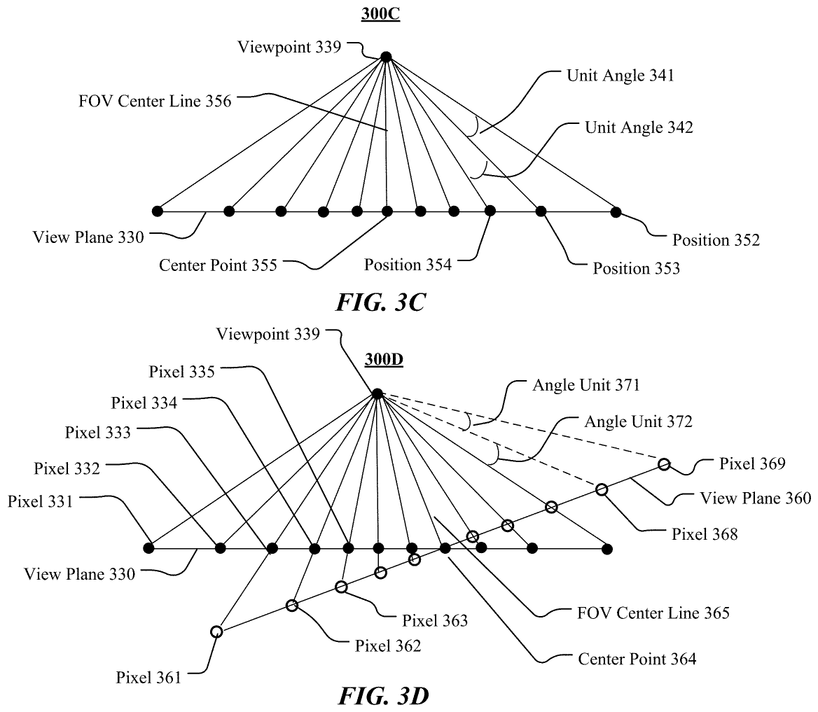

FIG. 3A illustrates an example scheme 300A with uniformly spaced pixels. As an example and not by way of limitation, an array of pixels may be uniformly spaced on a viewing plane 302, as illustrated in FIG. 3A. The view direction or view angle of the viewer may be presented by the FOV center line 308 which is perpendicular to the viewing plane 302. The pixel (e.g., 303, 304, 305) may be uniformly distributed on the viewing plan 302. In other words, the adjunct pixels (e.g., 303 and 304, 304 and 305) may have the same distance which is equal to a unit distance (e.g., 306, 307). Casting rays to each pixel from a viewpoint 301, the delta angles may vary over the array. The delta angles may be larger when the ray is closer the FOV center line 308 and may be smaller when the rays are farer from the FOV center line 308. The variance in the delta angles may be 2:1 for a 90-degree field of view. The tangents of the angles may incrementally change in size and the pixels may be distributed in a space which is referred to as a tangent space.

FIG. 3B illustrate an example scenario 300B where the view direction is rotated and the system tries to reuse the pixel values for the rotated view plane 313. The view direction 316 of the user may be represented by the vector line which is perpendicular to the rotated view plane 313. The view vectors (e.g., 317, 318, and 319) may be extended to show where the pixels computed for the original view plane 302 fall on the view plane 313. In other words, the system may try to shift the positions of the pixel values in the pixel array that are uniformly spaced on the view plane 302 to represented the scene as viewed from a different view direction or view angle 306 when the view plane 302 is rotated to the new view plane 313. For example, the pixel 315 on the view plane 302 may be shifted to the left direction for 3 pixels and can be used to represented the most left pixel on the rotated view plane 313 because the pixel 315 may fall on the position of the left most pixel 321 on the view plane 313, as illustrated in the FIG. 3B. However, if the pixel 314 on the view plane 302 is shifted to the left direction for 3 pixels and is used to represented the second left pixel on the rotated view plane 313, the system may have a mis-match in pixel positions because the pixel 314 falls on a pixel position 322 which is different from the second left pixel on the view plane 313 (the correct second left pixel position is between the pixels of 321 and 322), as illustrated in the FIG. 3B. The same principle may apply to other pixels in the array. In other words, a direction shifting on the pixels values in the pixel array may result in a non-uniform distribution of the corresponding pixel positions on the rotated view plane 313 and may result in distortion in the displayed content. The reason behind this may be explained because the rays cast from the viewpoint 301 to the uniformly distributed pixels on the view plane 302 have different space angles, which incrementally decrease from the center line 308 to the edges of the FOV. Thus, a direct pixel shifting of pixel values may be difficult to reuse to display the scene as viewed from a different view angle if the pixels of the display are uniformly distributed on the view plane 302. In this disclosure, the “pixel unit” may correspond to one single pixel in the pixel array. When a pixel array is shifted for N pixel units toward a direction (e.g., left or right direction), the all pixels in the pixel array may be shifted for N pixel positions toward that direction. In particular embodiments, the memory block storing the pixel array may have extra storage space to store the overflow pixels on either end. In particular embodiments, the memory block storing the pixel array may be used in a circular way so that the pixels shifting out of one end may be shifted into the other end and the memory block address may be circular.

FIG. 3C illustrates an example scheme 300C where the pixels are uniformly spaced in an angle space rather than the view plane. In particular embodiments, the system may use a display having pixel array being uniformly spaced in an angle space rather than uniformly spaced on the view plane. In other words, in the pixel array, each adjacent pixel pair in the array may have the same space angle corresponding to the unit angle. In particular embodiments, instead of using uniformly spacing the pixels on the view plane, the system may cast rays from the viewpoint 339 at constant incremental angles corresponding to an angle space. Another way to look at this is that, because changing the view angle changes all parts of the view plane by the same angle, the pixel positions must be spaced at uniform angle increments to allow shifting to be used. As an example, the pixel positions (e.g., 352, 353, 354) on the view plane 330 may be determined by casting rays from the viewpoint 339. The casted rays that are adjacent to each other may have the same space angle equal to a unit angle (e.g., 341, 342). The pixel positions (e.g., 352, 353, 354) may have non-uniform distances on the view plane 330. For example, the distance between the pixel positions 352 and 353 may be greater than the distance between the pixel positions 353 and 354. The adjacent pixels that are closer to the center point 355 may have smaller distances to each other and the adjacent pixels that are farer to the center point 355 may have larger distance to each other. FIG. 3C illustrates the equal-angled rays cast against the view plane 330. The view angle may be represented by the FOV center line 356 which is perpendicular to the view plane 330. The pixels may have variable spacing along the view plane 330. As a result, the pixels may be uniformly spaced or distributed in the angle space (with corresponding adjacent rays having equal space angles) and may have a non-uniform distribution pattern (i.e., non-uniform pixel distances) on the view plane 330.

FIG. 3D illustrates an example scheme 300D where the view plane 330 is rotated and the system tries to reuse the pixel values. As an example and not by way of limitation, the view direction of the user may be represented by the FOV center line 365 which is perpendicular to the rotated view plane 360. The pixel positions may be unequally spaced along the rotated view plane 360 and their spacing may be exactly identical to their spacing on the view plane 330. As a result, a simple shift of the pixel array may be sufficient to allow the tile processors to generate the new pixel arrays for the rotated view plane 360 perpendicular to the new view direction along the FOV center line 365. For example, the pixels 331, 332, and 333 may be shifted to the left side for 2 pixel units, these pixel may fall on the pixel positions of the pixels 361, 362, and 363 on the view plane 360 and thus, may be effectively to be reused to represent the corresponding pixels on the rotated view plane 360. The same principle may apply to all other pixels in the pixel array. As a result, the system may generate a new pixel array for the new view direction along the FOV center line 365 by simply shifting the pixel values in the pixel array according to the new view direction (or view angle) of the user. In particular embodiments, the system may generate the subframes in accordance with the user's view direction considering the user's view angle changes but without considering the distance change between the viewer and the view plane. By correcting or adjusting the subframes based on the user's view direction, the system may still be able to provide optimal display quality and excellent user experience.

In particular embodiments, the pixel array stored in the frame buffer may cover a larger area than the area to be actually displayed to include overflow pixels on the edges for facilitating the pixel shifting operations. As an example and not by way of limitation, the pixel array may cover a larger area than the view plane 330 and the covered area may extend beyond all edges of the view plane 330. It is notable that, although FIG. 3C-3D illustrate the view planes in one dimensional side view, the view planes may be two dimensional and the user's view angles can change along either the horizontal direction or vertical direction or both directions. In the example as illustrated in FIG. 3D, the pixel array may be shifted toward left side by 2 pixel units. As such, the two pixels 331 and 332 may be shifted out of the display area and the two pixels 368 and 369 may be shifted into the display area from the extra area that is beyond the display area. In particular embodiments, the buffer size may be determined based on the view angle ranges that is supported by the system combined with the desired angular separation of the uLEDs. When the system is designed to support a larger view angle range, the system may have a greater frame buffer to cover a larger extra area extending beyond the displayed area (corresponding to the view plane). When the system is designed to support a relatively smaller view angle range at the same uLED angular spacing, the system may have a relatively smaller buffer size (but still larger than the view plane area).

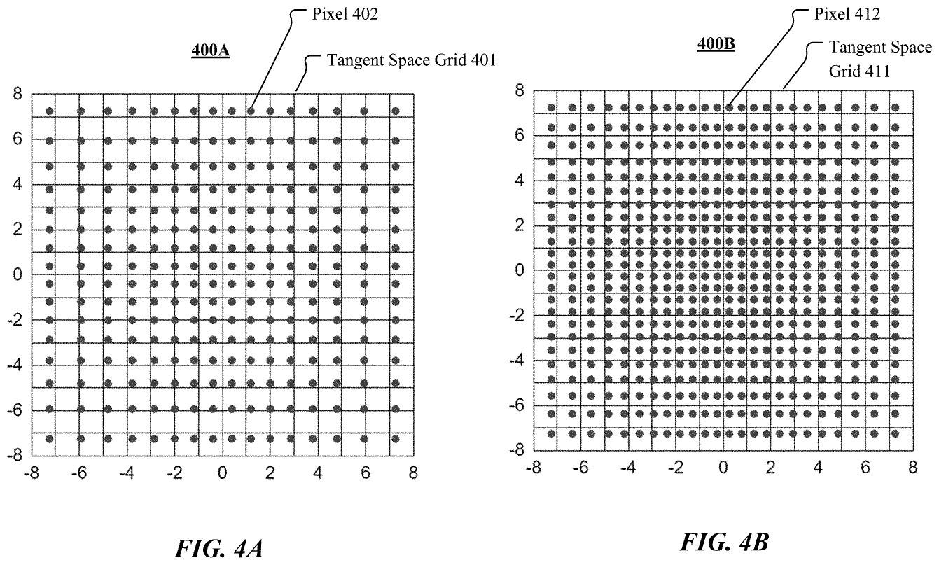

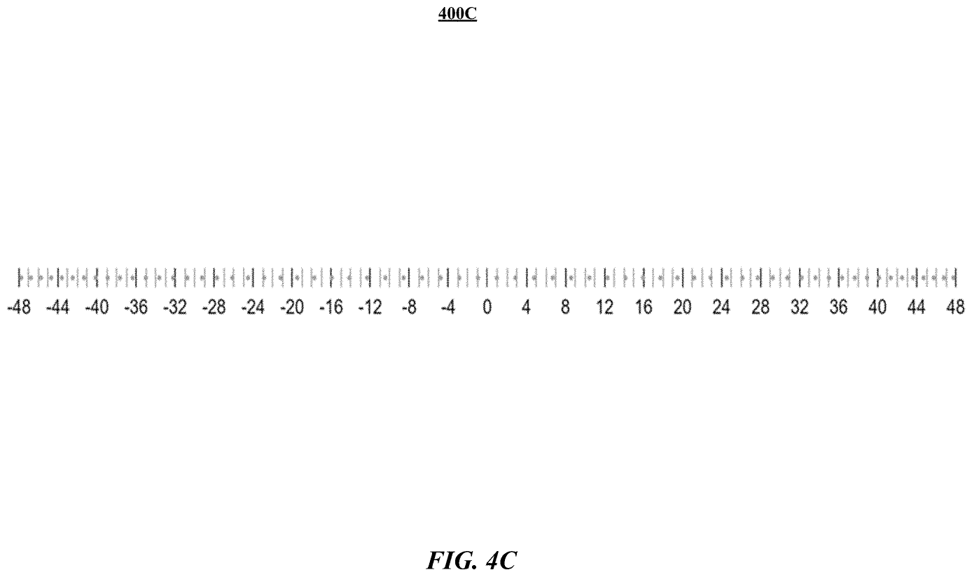

FIG. 4A illustrates an example angle space pixel array 400A with 16×16 pixels comparing to a 16×16 tangent space grid. As an example and not by way of limitation, the system may generate an angle apace pixel array, as illustrated by the dots in FIG. 4A. The pixels (e.g., 402) in the angle space pixel array may be uniformly space in the angle space along the horizontal and vertical directions. In other words, adjacent pixels along vertical or horizontal direction may have the same space angle in the angle space. The positions of these pixels may be determined using a ray casting process from the user's viewpoint to the view plane. As a result, the pixel positions may be not aligned with the tangent space grid 401, which has its grid units and intersections being uniformly spaced on the view plane.

FIG. 4B illustrates an example angle space pixel array 400B with 24×24 pixels comparing to a 16×16 tangent space grid. As an example and not by way of limitation, the system may generate an angle apace pixel array, as illustrated by the dots in FIG. 4B. The pixels (e.g., 412) in the angle space pixel array may be uniformly space in the angle space along the horizontal and vertical directions. In other words, adjacent pixels along vertical or horizontal direction may have the same space angle in the angle space. The positions of these pixels may be determined using a ray casting process from the user's viewpoint to the view plane. As a result, the pixel positions may be not aligned with the tangent space grid 411, which has its grid units and intersections being uniformly spaced on the view plane.

In particular embodiments, the pixel array may not need to be the same size as the LED array, even discounting overflow pixels around the edges, because the system may use a resampling process to determine the LED values based on the pixel values in the pixel array. By using the resampling process, the pixel array size may be either larger or smaller than the size of the LED array. For example, the angle space pixel arrays as shown in FIGS. 4A and 4B may correspond to a 90 degree FOV. In the pixel array as shown in FIG. 4A, the pixels may be approximately 0.8 grid units apart in the middle area of the grid and approximately 1.3 grid units apart at the edge area of the grid. As the number of pixels increases, an N-wide array of pixels on an N-wide LED grid may approach sqrt(2)/2 apart in the middle and sqrt(2) apart at the edge. In the angle space pixel array as shown in FIG. 4B, the pixels may be approximately 0.5 grid units apart in the middle and approximately 0.9 grid units apart at the edge area. For large numbers of pixels, an array of N/sqrt(2) pixels on an N-LED grid may be approximately 0.5 grid units apart in the middle and approximately 1 grid unit apart at the edges. In particular embodiments, the number of pixels in the angle space pixel array may be greater than the number of LEDs. In particular embodiments, the number of pixels in the angle space pixel array may be smaller than the number of LEDs. The system may determine the LED values based on the angle space pixel array using a resampling process. In particular embodiments, the system may use the angle space mapping and may compute more pixels in the central foveal region and compute less pixel in the periphery region.

It is notable that, in particular embodiments, the pixels on the respective view plane may correspond to pixel values that are computed to represent a scene to be displayed and the pixel positions on the view plane may be the intersecting positions as determined using ray casting process and pixel positions may not be aligned to the actual LED positions in the LED array. This may be true to the pixels on the view plane before after the rotation of the view plane. To solve this problem, the system may resample the pixel values in the pixel array to determine the LED values for the LED array. In particular embodiments, the LED values may include any suitable parameters for the driving signals for the LEDs including, for example, but not limited to, a current level, a voltage level, a duty cycle, a display period duration, etc. As illustrated in FIGS. 4A and 4B, the angle space rays and corresponding pixel positions may be not aligned to the tangent space grid (which may correspond to the LEDs positions). The system may interpolate pixel values in the pixel array to produce LED values based on the relative positions of the pixels and the LEDs. The system may specify the positions of the LEDs in angle space.

FIG. 4C illustrates an example LED array 400C including 64 LEDs on a 96 degree-wide angle space grid. In FIG. 4C, the grid as represented by the vertical short lines may correspond to 96 degrees as uniformly spaced in the angle space. The dots may represent the LED positions within the angle space. As shown in FIG. 4C, this chart may have an opposite effect of the charts as shown in FIGS. 4A and 4B, with LEDs becoming closer in angle space toward the edges of the display region. These LED positions may be modified in two ways before being used for interpolating pixel values to produce LED brightness values. First, changes in the view angle may alter the LED positions with respect to the user's viewpoint. With N pixels in a 90 degree field of view, each pixel may have an angular width of 90/N degrees. For example, with 3000 pixels, each pixel may have 0.03 degrees wide. The system may support even larger view angle changes than 90 degrees by shifting the pixel array. Therefore, the variance needed to compute LED values at any exact view angle may ±½ a pixel. In particular embodiments, uLEDs may be effectively spaced further apart at the edges due to lens distortion, which is discussed below.

If the pixels are uniformly space along the view plane, the pixels may be farther apart at one portion of the view plane than at another portion of the view plane and a memory shifting solution may have to shift pixels by different amounts at different places in the array. In particular embodiments, by using the pixels uniformly distributed in the angle space, the system may allow uniform shifts of pixels for generating subframes in response to the user's view angle changes. Furthermore, because uniformly spaced pixels in the angle space results in more dense pixels in the central areas of the FOV, the angle space pixel array may provide a foveation (e.g., 2:1 foveation) from the center to the edges of the view plane. In general, the system may have the highest resolution at the center of the array and may tolerate lower resolution at the edges. This may be true even without eye tracking since the user's eyes seldom move very far from the center for very long time before moving back to near the center.

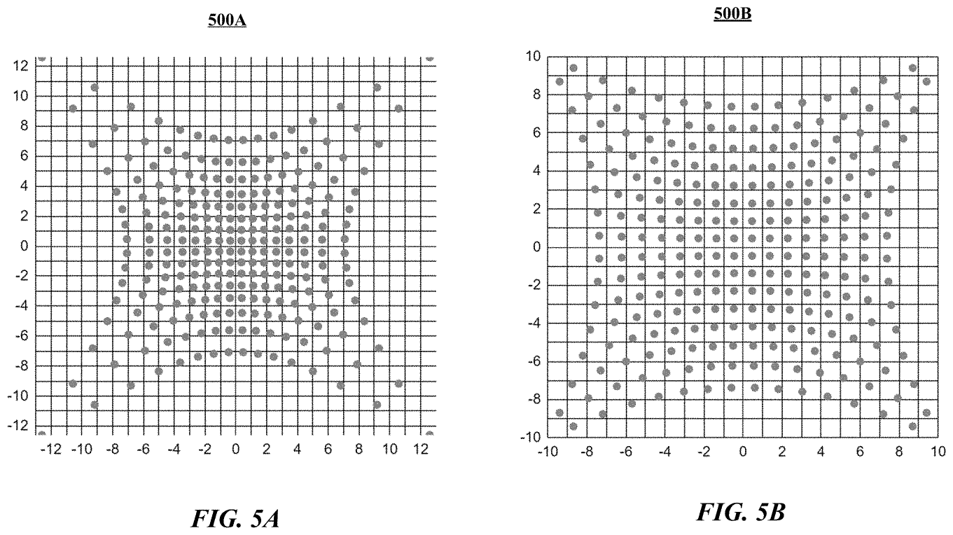

FIG. 5A illustrates an example pattern 500A of an LED array due to lens distortion. In particular embodiments, the lens distortion may cause a large change in the LED positions. For example, a typical lens may cause pincushion distortion on a uniform (in tangent space) grid of LEDs. The LED pattern as shown in FIG. 5A may include a 16×16 array of LEDs with the lens distortion for the uOLED product. The 90 degree FOV may correspond to the region of [−8, +8]. Many corner uOLEDs may be partially or fully clipped in order to create a rectangular view window. A more extreme distortion may differ per LED color.

FIG. 5B illustrates an example pattern 500B of an LED array with the same pincushion distortion in FIG. 5A but mapped into an angle space. The coordinates (±8, 0) and (0, ±8) may represent 45 degree angles on the X and Y axes for a 90 degree FOV. Equal increments in X or Y may represent equal angle changes along the horizontal or vertical direction. As shown in FIG. 5B, the pincushion distortion effect may be close to linear in the horizontal and vertical directions when measured in angle space. As a result, the angle space mapping may almost eliminate pincushion distortion along the major axes and greatly reduce it along other angle directions.

In particular embodiments, each tile processor may access a defined region of memory plus one pixel along the edges from adjacent tile processors. However, in particular embodiments, a much larger variation may be supported due to lens distortion. In general, a lens may produce pincushion distortion that varies for different frequencies of light. In particular embodiments, the pincushion distortion may be corrected by barrel distorting the pixels prior to display when a standard VR system is used. In particular embodiments, the barrel distorting may not work because the system may need to keep the pixels in angle space to use pixel shifting method to generate subframes in response to changes of the view angle. As a result, the system may use the memory array to allow each tile processor to access pixels in a local region around each tile processor, depending on the magnitude of the distortion that can occur in that tile processor's row or column and the system may use the system architectures described in this disclosure for supporting this function. As discussed earlier in this disclosure, in particular embodiments, the pixel array stored in the memory may be not aligned with the LED array. The system may use a resampling process to determine the LED values based on the pixel array and the relative positions of the pixels in the array and the LED positions. The pixel positions for the pixel array may be with respect to the view plane and may be determined using a ray casting process and/or a rotation process. In particular embodiments, the system may correct the lens distortion during the resampling process taking into consideration of the LED positions as distorted by the lens.

In particular embodiments, depending on the change of the user's view angle, the pixels in the pixel array may need to be shifted by a non-integer time of pixel units. In this scenario, the system may first shift the pixels by an integer time of pixel units using the closest integer to the target shifting offset. Then, the system may factor in the fraction of pixel units corresponding to the difference between the actually shifted offset and the target offset during the resampling process for determining LED values based on the pixel array and the relative positions of the pixel positions and LED positions. As an example and not by way of limitation, the system may need to shift the pixels in the array for 2.75 pixel units toward left side. The system may first shift the pixel array by 3 pixel units toward left. Then, the system may factor in the 0.25 position difference during the resampling process. As a result, the pixel values in the generated subframes may be correctly calculated corresponding to the 2.75 pixel units. As another example, the system may need to shift the pixel array by 2.1 pixel unit toward right side. The system may first shift the pixel array by 2 pixel unit and may factor in the 0.1 pixel unit during the resampling process. As a result, the pixel values in the generated subframes may be corrected determined corresponding to the 2.1 pixel units. During the resampling process, the system may use an interpolation operation to determine a LED value based on a corresponding 2×2 pixels. The interpolation may be based on the relative positions of the 2×2 pixels with respect to the position of the LED, taking into considerations of (1) the difference fraction of the target shifting offset and actually shifted offset; and (2) the lens distortion effect that distort the relative positions of the pixels and LEDs.

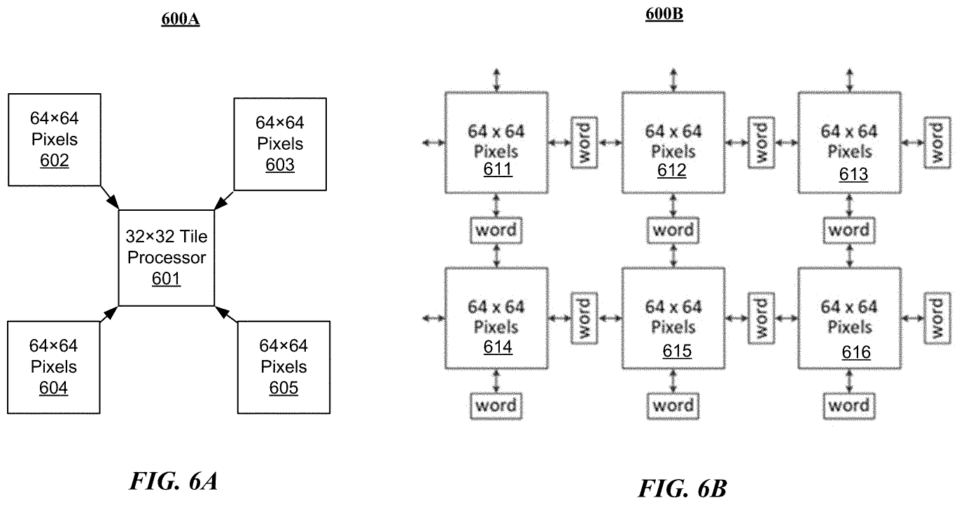

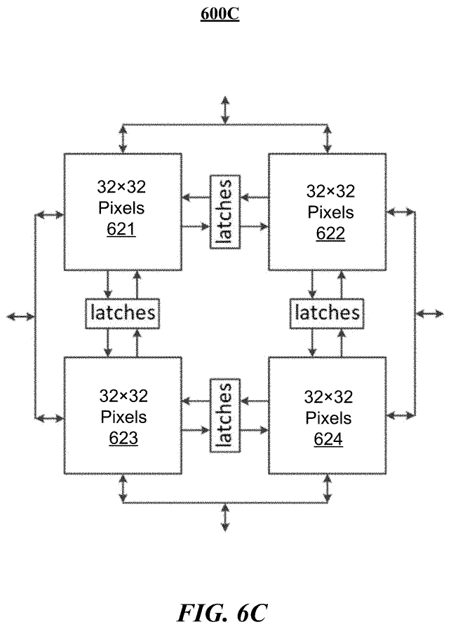

FIG. 6A illustrates an example architecture 600A including a tile processor 601 and four pixel memory units (e.g., 602, 603, 604, 605). In particular embodiments, the system may provide a means for the tile processors to access memory. As discussed earlier, LED positions and pixel positions may be not aligned, both due to pixels being specified in angle space and due to lens distortion correction in the positions of the LEDs. The system optics may be designed to reduce the lens distortion to a general level. To correct the exact distortion, the system may use programmable solution to correct the lens distortion during the resampling process of the pixel array. As a result, the system may allocate specific regions of the pixel array to specific tile processors. In particular embodiments, the system may use array processors (e.g., tile processors) that are sit behind an array of LEDs to process the pixel data stored in the local memory units. In particular embodiments, each individual tile processor used in the system may be a logic unit that processes a tile of LEDs (e.g., 32×32). Since the pixel spacing varies relative to the LEDs, the amount of memory accessible to each tile processor may vary across the array. In particular embodiments, the pixel array may be separated from the tile processors that compute LED brightness values. Also, the pixel array may be shifted and updated by the tile processors to generate the subframes in response to the user's view angel changes. As an example and not by way of limitation, the architecture 600A may include a tile processor 601 which can process a tile of 32×32 LEDs and four pixel memory units 602, 603, 604, and 605. Each of the pixel memory unit may store a 64×64 pixel array. The tile processor 601 may access the pixel data in these pixel memory units, shift the pixels according to the changes of the user's view angles, and resample the pixel array to determine the corresponding LED brightness values. In particular embodiments, the system may support having pixels at half the spacing of the LEDs. For example, a 32×32 tile process may have memory footprint up to 65×65 pixels (including extra pixels on the edges). In particular embodiments, reding from four 64×64 memory units may support reading 65×65 pixels at any alignment, so long as the tile processor is connected to the correct four pixel memory units.

In particular embodiments, the system may use a bilinear interpolation process to resample the pixel array to determine the LED values. To determine the values for one LED, the system may need to access an unaligned 2×2 of pixels. This may be accomplished in a single clock by dividing the 64×64 pixel block into four interleaved blocks. One pixel memory unit or block that store pixels may be used as a reference unit and may have even horizontal (U) and vertical (V) addresses. The other three memory units may store pixels with other combinations of even and odd (U,V) address values. A single (U,V) address may then be used to compute an unaligned 2×2 block that is accessed by the four memory units. As a result, the tile processor may access a 2×2 of pixels in a single cycle, regardless of which of the connected pixel array memory unit the desired pixels are in or whether they are in two or all four of the memory units.

In particular embodiments, the system may have pixel memory units with pre-determined sizes to arrange for no more than four tile processors to connect to each memory unit. In that case, on each clock, one fourth of the tile processors may read from the attached memories, so that it takes four clocks to read the pixel data that is needed to determine LED values for one LED. In particular embodiments, the system may have about 1000 LEDs per tile processor, 100 subframes per composited/rendered frame and 100 rendering frames per second. The system may need 40M operations per second for the interpolation process. When the system runs at 200 MHz, reading pixels for the LEDs may need 20% of the processing time. In particular embodiments, the system may also support interpolation on 4×4 blocks of pixels. With the memory design as described above, the system may need 16 accesses per tile processor. This may increase the time required for 160M accesses per second, or 80% of the processing time when the clock rate is 200 MHz.

In particular embodiments, the system may support changes of view direction while the display frame is being output to the LED array. At the nominal peak head rotation rate of 300 degrees per second, nominal pixel array size of 3000×3000 pixels, a 90-degree field of view, and 100 fps, the view may change by 3 degrees per frame. As a result, the pixels may shift by up to 100 positions over the course of a display frame. Building the pixel array as an explicit shifter may be expensive. The shift may need to occur 10,000 times per second (100 fps rendering rate and 100 sub-frames per rendered frame). With an array that is 2,560 LEDs wide, shifting a single line by one position may require 2,560 reads and 2,560 writes, or 256,000 reads and writes per rendered frame. Instead, in particular embodiments, the memory may be built in blocks in a size of, for example, 64×64 . This may allow 63 pixels per row to be accessed at offset positions within the block. Only the pixels at the edges of each block may need to be shifted to another block, reducing the number of reads and writes by a factor or 64. As a result, it may only take about 4,000 reads and 4,000 writes to shift each row of the array by one position.

FIG. 6B illustrates an example memory lay out 600B to allow parallel per-memory unit shifting. As an example and not by way of limitation, the system may include six pixel memory units (e.g., 611, 612, 613, 614, 615, and 616) with the extra word of storage between each memory unit. To shift one pixel to the left, the sequence of steps may be as follows for each row of each array: (1) reading pixel[0] and writing to the left hand inter-block word; (2) reading pixel[N] and writing pixel[N-1] for N=1 to 63; (3) reading the right hand inter-block work and writing to pixel[63].

FIG. 6C illustrates an example memory layout 600C to support pixel shifting with a 2×2 access per pixel block. The memory layout 600C may include four pixel blocks (i.e., pixel memory units) 621, 622, 623, and 624. The process may be essentially the same as the process described in the earlier section of this disclosure, except that each access may read a pixel in each 32×32 sub-block, which is latched between the blocks. In most steps, the two values may swap sub-blocks to be written to the next pixel horizontally or vertically. For the first and last accesses, one value may either go to or comes from the inter-block word registers. Using 2×2 access sub-blocks, each block may shift one pixel either horizontally or vertically in 33×32×2 clocks, counting separate clocks for the read and write. With 100 shifts per rendered frame and 100 rendered frames per second, the total may about 21M clocks. If the chip is clocked at 210 MHz, this may be about 10% of the processing time.

In particular embodiments, the display frame may be updated at a nominal rate of 100 fps. This may occur in parallel with displaying the previous frame, so that throughout the frame the LEDs may display a mix of data from the prior and current frames. In particular embodiments, the system may use an interleave of old and new frames for translation and torsion. The translation and torsion may include for all kinds of head movement except changing the pitch (vertical) and yaw (horizontal) of the view angle. The system may ensure that the display frame can be updated while accounting for changes in pitch and yaw during the frame.

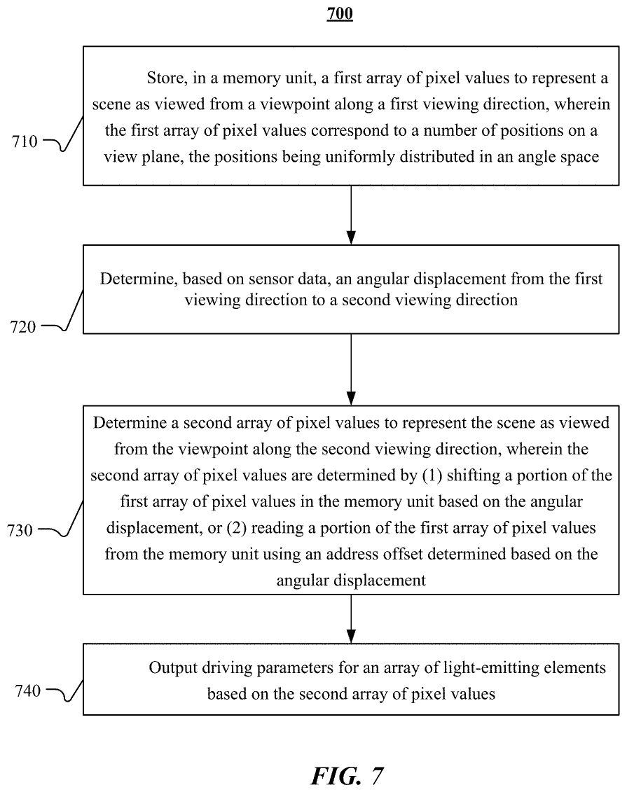

FIG.7 illustrates an example method 700 of adjusting display content in according to the user's view directions. The method may begin at step 710, where a computing system may store, in a memory unit, a first array of pixel values to represent a scene as viewed from a viewpoint along a first viewing direction. The first array of pixel values may correspond to a number of positions on a view plane. The positions may be uniformly distributed in an angle space. At step 720, the system may determine, based on sensor data, an angular displacement from the first viewing direction to a second viewing direction. At step 730, the system may determine a second array of pixel values to represent the scene as viewed from the viewpoint along the second viewing direction. The second array of pixel values may be determined by: (1) shifting a portion of the first array of pixel values in the memory unit based on the angular displacement, or (2) reading a portion of the first array of pixel values from the memory unit using an address offset determined based on the angular displacement. At step 740, the system may output the second array of pixel values to a display.

In particular embodiments, the pixels on the respective view plane may correspond to pixel values that are computed to represent a scene to be displayed and the pixel positions on the view plane may be the intersecting positions as determined using ray casting process and pixel positions may not be aligned to the actual LED positions in the LED array. This may be true to the pixels on the view plane before after the rotation of the view plane. In particular embodiments, the system may resample the pixel values in the pixel array to determine the LED values for the LED array. In particular embodiments, the LED values may include any suitable parameters for the driving signals for the LEDs including, for example, but not limited to, a current level, a voltage level, a duty cycle, a display period duration, etc. The system may interpolate pixel values in the pixel array to produce LED values based on the relative positions of the pixels and the LEDs. The system may specify the positions of the LEDs in angle space. In particular embodiments, the system may use the tile processor to access the pixel data in pixel memory units, shift the pixels according to the changes of the user's view angles, and resample the pixel array to determine the corresponding LED brightness values. In particular embodiments, the system may use a bilinear interpolation process to resample the pixel array to determine the LED values.

In particular embodiments, the first array of pixel values may be determined by casting rays from the viewpoint to the scene. The positions on the view plane may correspond to intersections of the cast rays and the view plane. The casted rays may be uniformly distributed in the angle space with each two adjacent rays having a same angle equal to an angle unit. In particular embodiments, the angular displacement may be equal to an integer times of the angle unit. In particular embodiments, the second array of pixel values may be determined by shifting the portion of the first array of pixel values in the memory unit by the integer times of a pixel unit. In particular embodiments, the address offset may correspond to the integer times of a pixel unit. In particular embodiments, the angular displacement may be equal to an integer times of the angle unit plus a fraction of the angle unit. In particular embodiments, the second array of pixel values may be determined by: shifting the portion of the first array of pixel values in the memory unit by the integer times of a pixel unit; and sampling the second array of pixel values with a position shift equal to the fraction of the pixel unit. In particular embodiments, the address offset for reading the first array of pixel values from the memory unit may be determined based on the integer times of a pixel unit. The system may sample the second array of pixel values with a position shift equal to the fraction of a pixel unit. In particular embodiments, the display may have an array of light-emitting elements. Outputting the second array of pixel values to the display may include: sampling the second array pixel values based on LED positions of the array of light-emitting elements; determining driving parameters for the array of light-emitting elements based on the sampling results; and outputting the driving parameters to the array of light-emitting elements. In particular embodiments, the driving parameters for the array of light-emitting elements may include a driving current, a driving voltage, and a duty cycle.

In particular embodiments, the system may determine a distortion mesh for distortions caused by one or more optical components. The LED positions may be adjusted based on the distortion mesh. The sampling results may be corrected for the distortions caused by the one or more optical components. In particular embodiments, the first memory unit may be located on a component of the display comprising an array of light-emitting elements. In particular embodiments, the memory unit storing the first array of pixel values may be integrated with a display engine in communication with and may be remote (e.g., not in the same physical component) to the display. In particular embodiments, the array of light-emitting elements may be uniformly distributed on a display panel of the display. In particular embodiments, the display may provide a foveation ratio of approximately 2:1 from a center of the display to edges of the display. In particular embodiments, the first array of pixel values may correspond to a scene area that is larger than an actually displayed scene area on the display. In particular embodiments, the second array of pixel values may correspond to a subframe to represent the scene. The subframe may be generated at a subframe rate higher than a mainframe rate. In particular embodiments, the memory unit may have extra storage space to catch overflow pixel values. One or more pixel values in the first array of pixel values may be shifted to the extra storage space of the memory unit.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for adjusting display content in according to the user's view directions including the particular steps of the method of FIG. 7, this disclosure contemplates any suitable method for adjusting display content in according to the user's view directions including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

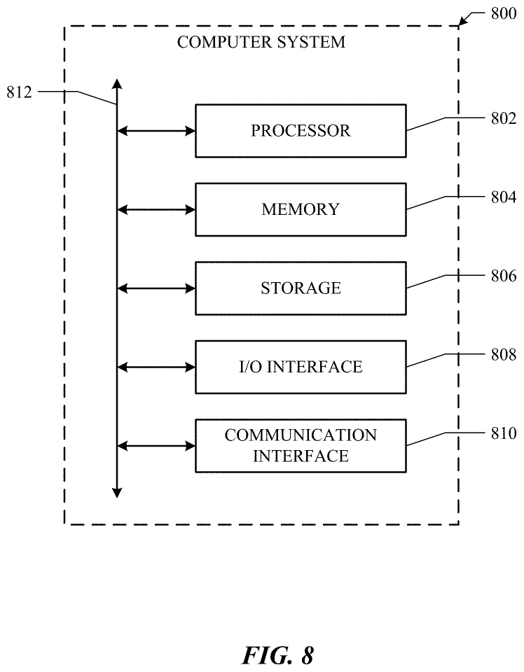

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 1006, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 1006; decode and execute them; and then write one or more results to an internal register, an internal cache, memory 804, or storage 1006. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 1006, and the instruction caches may speed up retrieval of those instructions by processor 802. Data in the data caches may be copies of data in memory 804 or storage 1006 for instructions executing at processor 802 to operate on; the results of previous instructions executed at processor 802 for access by subsequent instructions executing at processor 802 or for writing to memory 804 or storage 1006; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 1006 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 1006 or elsewhere) and operates only on data in one or more internal registers or internal caches or in memory 804 (as opposed to storage 1006 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 800, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 802 and storage 1006, where appropriate. Where appropriate, storage 1006 may include one or more storages 1006. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
storing, in a memory unit, a first array of pixel values to represent a scene as viewed from a viewpoint along a first viewing direction, wherein the first array of pixel values correspond to a plurality of positions on a view plane, the plurality of positions being uniformly distributed in an angle space;
determining, based on sensor data, an angular displacement from the first viewing direction to a second viewing direction;
determining a second array of pixel values to represent the scene as viewed from the viewpoint along the second viewing direction, wherein the second array of pixel values are determined by (1) shifting a portion of the first array of pixel values in the memory unit based on the angular displacement, or (2) reading a portion of the first array of pixel values from the memory unit using an address offset determined based on the angular displacement; and
outputting the second array of pixel values to a display.

2. The method of claim 1, wherein the first array of pixel values are determined by casting rays from the viewpoint to the scene, wherein the plurality of positions correspond to intersections of the casted rays and the view plane, and wherein the casted rays are uniformly distributed in the angle space with each two adjacent rays having a same angle equal to an angle unit.

3. The method of claim 2, wherein the angular displacement is equal to an integer times of the angle unit.

4. The method of claim 3, wherein the second array of pixel values are determined by shifting the portion of the first array of pixel values in the memory unit by the integer times of a pixel unit.

5. The method of claim 3, wherein the address offset corresponds to the integer times of a pixel unit.

6. The method of claim 2, wherein the angular displacement is equal to an integer times of the angle unit plus a fraction of the angle unit.

7. The method of claim 6, wherein the second array of pixel values are determined by:
shifting the portion of the first array of pixel values in the memory unit by the integer times of a pixel unit; and
sampling the second array of pixel values with a position shift equal to the fraction of the pixel unit.

8. The method of claim 6, wherein the address offset for reading the first array of pixel values from the memory unit is determined based on the integer times of a pixel unit, and wherein the method further comprises:
sampling the second array of pixel values with a position shift equal to the fraction of a pixel unit.

9. The method of claim 1, wherein the display comprises an array of light-emitting elements, and wherein outputting the second array of pixel values to the display comprises:
sampling the second array pixel values based on LED positions of the array of light-emitting elements;
determining driving parameters for the array of light-emitting elements based on the sampling results; and
outputting the driving parameters to the array of light-emitting elements.

10. The method of claim 9, wherein the driving parameters for the array of light-emitting elements comprise a driving current, a driving voltage, and a duty cycle.

11. The method of claim 9, further comprising:
determining a distortion mesh for distortions caused by one or more optical components, wherein the LED positions are adjusted based on the distortion mesh, and wherein the sampling results are corrected for the distortions caused by the one or more optical components.

12. The method of claim 1, wherein the first memory unit is located on a component of the display comprising an array of light-emitting elements.

13. The method of claim 1, wherein the memory unit storing the first array of pixel values is integrated with a display engine in communication with and remote to the display.

14. The method of claim 1, wherein the array of light-emitting elements are uniformly distributed on a display panel of the display.

15. The method of claim 1, wherein the display provides a foveation ratio from a center of the display to edges of the display based on a field of view, and wherein pixels of the display that are farer from the center have larger distances to each other.

16. The method of claim 1, wherein the first array of pixel values correspond to a scene area that is larger than an actually displayed scene area on the display.

17. The method of claim 1, wherein the second array of pixel values correspond to a subframe to represent the scene, wherein the subframe is generated at a subframe rate higher than a mainframe rate, and wherein the computing system has a variable framerate for the mainframe or the subframe rate.

18. The method of claim 1, wherein the memory unit comprises extra storage space to catch overflow pixel values, and wherein one or more pixel values in the first array of pixel values are shifted to the extra storage space of the memory unit.

19. One or more computer-readable non-transitory storage media embodying software that is operable when executed to:
store, in a memory unit, a first array of pixel values to represent a scene as viewed from a viewpoint along a first viewing direction, wherein the first array of pixel values correspond to a plurality of positions on a view plane, the plurality of positions being uniformly distributed in an angle space;
determine, based on sensor data, an angular displacement from the first viewing direction to a second viewing direction;
determine a second array of pixel values to represent the scene as viewed from the viewpoint along the second viewing direction, wherein the second array of pixel values are determined by (1) shifting a portion of the first array of pixel values in the memory unit based on the angular displacement, or (2) reading a portion of the first array of pixel values from the memory unit using an address offset determined based on the angular displacement; and
output the second array of pixel values to a display.

20. A system comprising:
one or more non-transitory computer-readable storage media embodying instructions; and
one or more processors coupled to the storage media and operable to execute the instructions to:
store, in a memory unit, a first array of pixel values to represent a scene as viewed from a viewpoint along a first viewing direction, wherein the first array of pixel values correspond to a plurality of positions on a view plane, the plurality of positions being uniformly distributed in an angle space;
determine, based on sensor data, an angular displacement from the first viewing direction to a second viewing direction;
determine a second array of pixel values to represent the scene as viewed from the viewpoint along the second viewing direction, wherein the second array of pixel values are determined by (1) shifting a portion of the first array of pixel values in the memory unit based on the angular displacement, or (2) reading a portion of the first array of pixel values from the memory unit using an address offset determined based on the angular displacement; and
output the second array of pixel values to a display.
